(19) United States
(12) Patent Application Publication
(10) Pub. No.: US 2018/0029067 A1
(43) Pub. Date: Feb. 1, 2018

(54) Dispensing System, Packaging System, Package, Dispensing Assembly, And Method Of Dispensing A Product

(71) Applicant: Cryovac, Inc., Charlotte, NC (US)

(72) Inventor: Hubert J. Cook, Simpsonville, SC (US)

(21) Appl. No.: 15/548,926

(22) PCT Filed: Feb. 5, 2016
(86) PCT No.: PCT/US2016/016737

§ 371 Date: Aug. 4, 2017

Related U.S. Application Data
(60) Provisional application No. 62/112,958, filed on Feb. 6, 2015.

(51) Int. Cl. B05C 17/005; B05C 17/01

(52) U.S. Cl. CPC B05C 17/00583; B05C 17/00586; B05C 17/0123; B05C 17/00506

(57) ABSTRACT

The invention includes a dispensing system for dispensing a packaged product, e.g. a condiment, onto one or more areas. A package including a pouch having the product therein cooperates with a dispensing gun to dispense a dose of product. The invention includes a packaging system that includes a container such as a rigid sleeve, and a flexible package with an aperture, and an internal fitment disposed in the aperture, the internal fitment comprising a pierceable or frangible membrane, the package including a flexible pouch; a dispensing assembly for dispensing a product from the package, including a valve and optionally a piercing component configured to pierce the membrane; and a method of dispensing a product.

### FIELD OF THE INVENTION

The present invention relates generally to a dispensing system for dispensing a packaged product; a packaging system that includes a container and a flexible package; a package with a frangible seal; a dispensing assembly; a dispensing gun system; a method of making a package; and a method of dispensing a product.

### BACKGROUND OF THE INVENTION

In food service, and in particular in the field of high volume fast food service, it is frequently desired that food be supplemented by condiments such as ketchup, mustard, mayonnaise, and the like. It has recently become customary in retail fast service chain food outlets to use a wide variety of devices to dispense a measured quantity of flowable product. For example, a trigger-activated dispensing gun assembly has commonly been used in “back of the restaurant” operations for discharging one or more condiments or sauces. The gun assembly dispenses a quantity of a condiment with each pull of a gun trigger. The gun assembly includes a cylindrical container that houses the condiment and cooperates with a trigger in a gun to dispense the condiment out of a nozzle. However, the gun, cylindrical container, and nozzle are typically disassembled and/or cleaned each time the container is emptied and/or refilled In addition, the gun assembly typically can be messy, as condiment can drip from the nozzle between uses; conventional systems can be labor intensive; and the container can sometimes become damaged and not insert properly into the gun.

### SUMMARY OF THE INVENTION

In a first aspect, a dispensing system comprises a packaging system comprising a container comprising first and second openings and an interior, a package positioned within the container interior, the package comprising a pouch comprising a first and second panel with an aperture, an internal fitment disposed in the aperture, the internal fitment comprising a membrane, and a flowable product disposed in the pouch. The dispensing system may also include a dispensing assembly optionally comprising a piercing component configured to pierce the membrane. Alternatively, the membrane may include a frangible seal. The dispensing system may also include a dispensing gun into which the packaging system is disposed.

In a second aspect, a packaging system comprises a container comprising first and second openings and an interior, a package positioned within the container interior, the package comprising a pouch comprising a first and second panel with an aperture, an internal fitment disposed in the aperture, the internal fitment comprising a membrane, and a flowable product disposed in the pouch. The packaging system may also include a dispensing assembly optionally comprising a piercing component configured to pierce the membrane. Alternatively, the membrane may include a frangible seal.

In a third aspect, a package comprises a pouch comprising a first and second panel with an aperture, an internal fitment disposed in the aperture, the internal fitment comprising a membrane, and a flowable product disposed in the pouch. The membrane may include a frangible seal.

In a fourth aspect, a dispensing assembly comprises a valve, a housing, a connecting portion that is configured to functionally cooperate with and engage a container or pouch fitment, and one of either a frangible membrane on the fitment and a piercing component to puncture a membrane on the fitment.

In a fifth aspect, a method of dispensing a product comprises providing a packaging system comprising a container comprising a first and second end, first and second openings and an interior; a package positioned within the container interior, the package comprising a pouch comprising a first and second panel with an internal fitment comprising a membrane, and a flowable product disposed in the pouch; and a dispensing assembly. The method further comprising the steps of providing a dispensing gun configured to house the packaging system, installing the packaging system into the dispensing gun, initiating linear movement of a pusher plate through the interior of the container to cause the flowable product to be dispensed through the dispensing assembly.

### BRIEF DESCRIPTION OF THE DRAWINGS

The present invention is illustrated in various embodiments by reference to the following drawing figures wherein:

FIG. 1a is a side elevational view of a dispensing system;

FIG. 2 is a front elevation view of a package in a container.

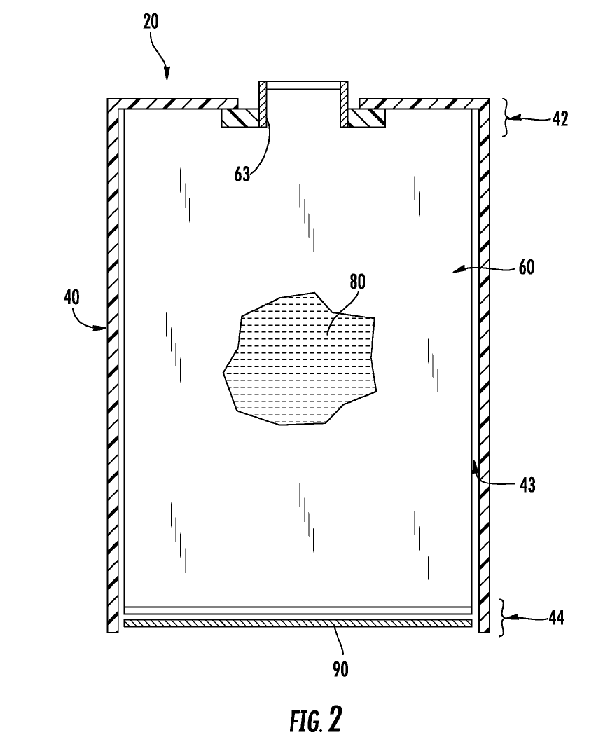

FIG. 3 is a front elevation view of a pouch.

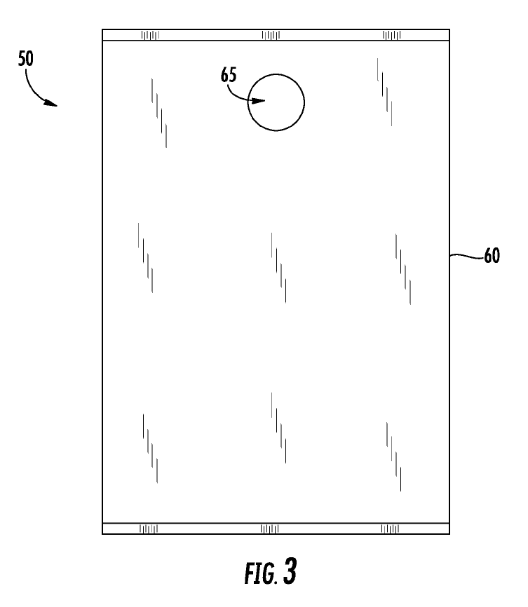

FIG. 4 is a schematic fragmentary view of a pouch with a fitment.

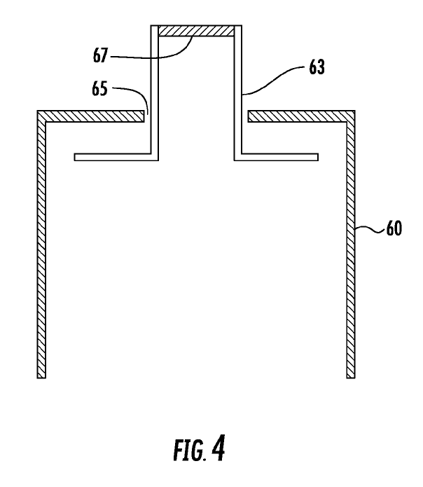

FIG. 5 is an exploded schematic view of a dispensing assembly.

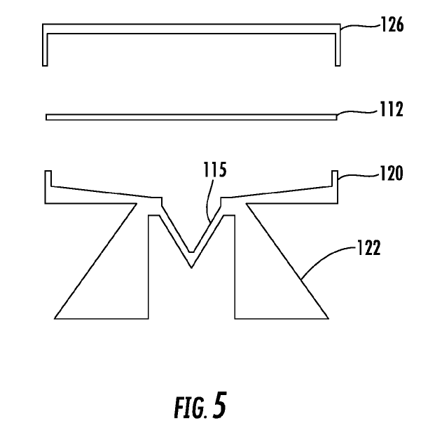

FIG. 6 is a schematic view of a dispensing assembly as it is being installed on a pouch disposed in a container.

FIG. 7 is a schematic view of a packaging system.

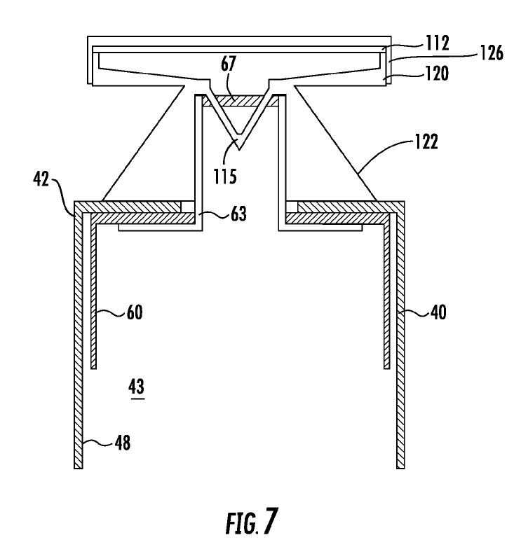

FIG. 8 is a schematic view of a packaging system.

### DETAILED DESCRIPTION OF THE INVENTION

### I. Definitions

“A”, “an”, and “the” as used herein do not limit to the singular unless expressly so stated. Thus, for example, reference to “a package” can include a plurality of such packages, and so forth.

“Abuse layer” and the like herein refers to an outer film layer and/or an inner film layer, so long as the film layer serves to resist abrasion, puncture, and other potential causes of reduction of package integrity, as well as potential causes of reduction of package appearance quality. Abuse layers can comprise any polymer, so long as the polymer contributes to achieving an integrity goal and/or an appearance goal. In some embodiments, the abuse layer can comprise polyamide, ethylene/propylene copolymer, and/or combinations thereof.

“Condiment” and the like herein refers to (but is not limited to) ketchup, mustard, guacamole, sour cream, salsa, nacho cheese, taco sauce, barbecue sauce, tartar sauce, mayonnaise, jams, jellies, spices, and the like. In some embodiments, the term “condiment” can include any and all additives that a user can choose to add to any food item for any purpose, e.g. for organoleptic, processing, or preservative purposes.

“Container” and the like herein refers to tubes, bottles, jars, tubs, cylinders, vessels, flasks, chambers, and the like, whether pliable or rigid.

“Exterior” refers to the outside portion of an article.

“Filled” and the like herein, with respect to a pouch, refers to a pouch that has been filled with a product in a manner consistent with a commercial filling operation. Thus, a pouch may or may not be 100% filled.

“Film” and the like herein refers to a laminate, sheet, web, coating, or the like, that can be used to package a product. The film can be a rigid, semi-rigid, or flexible product. In some embodiments, the film is produced as a fully coextruded film, i.e., all layers of the film emerging from a single die at the same time. In some embodiments, the film is made using a flat cast film production process or a round cast film production process. Alternatively, the film can be made using a blown film process, double bubble process, triple bubble process, or adhesive or extrusion coating lamination.

“Flexible” and the like herein refers to materials that are pliable and easily deform in the presence of external forces.

“Frangible seal” and the like herein refer to a seal that is sufficiently durable to allow normal handling and storage, but ruptures or substantially ruptures under applied pressure. In some embodiments, suitable frangible seals will have a peel strength of from 0.5 to less than 5 pounds/inch as measured by ASTM F88.

“Heat seal” and the like herein refers to any seal of a first region of a film surface to a second region of a film surface, wherein the seal is formed by heating the regions to at least their respective seal initiation temperatures. Heat-sealing is the process of joining two or more thermoplastic films or sheets by heating areas in contact with each other to the temperature at which fusion occurs, usually aided by pressure. In some embodiments, heat-sealing can be inclusive of thermal sealing, melt-bead sealing, impulse sealing, dielectric sealing, and/or ultrasonic sealing. The heating can be performed by any one or more of a wide variety of means, such as (but not limited to) a heated bar, hot wire, hot air, infrared radiation, ultrasonic sealing, and the like.

“Interior” and the like herein refers to the inside portion of an article.

“Multilayer film” and the like herein refers to a thermoplastic film having one or more layers formed from polymeric or other materials that are bonded together by any conventional or suitable method, including one or more of the following methods: coextrusion, extrusion coating, lamination, vapor deposition coating, solvent coating, emulsion coating, or suspension coating.

“Outlet” and the like herein refers to an aperture, orifice, opening, chute, passage, or similar channel through which a product can exit the disclosed packaging system.

“Panel” and the like herein refers to a wall or major section of a pouch. A first and second panel can be derived from two pieces of film joined together by any suitable means, such as heat sealing. Alternatively, a single web of film can be folded into a tubular configuration, and longitudinally and transversely sealed to create a pouch exhibiting a first and second panel.

“Pouch” and the like herein refers to any of a wide variety of containers known in the art, including (but not limited to) bags, packets, packages, and the like.

“Product” and the like herein refers to any of a wide variety of food or non-food items that can be packaged in the disclosed systems. In some embodiments, the product is a condiment, and/or a flowable product.

“Seal” and the like herein refers to any seal of a first region of a film surface to a second region of a film or substrate surface. In some embodiments, the seal can be formed by heating the regions to at least their respective seal initiation temperatures using a heated bar, hot air, infrared radiation, ultrasonic sealing, and the like. In some embodiments, the seal can be formed by an adhesive. Alternatively or in addition, in some embodiments the seal can be formed using a UV or e-beam curable adhesive seal.

“Seal layer” and the like herein refers to an outermost film layer or layers involved in heat sealing of the film to itself, to another film layer of the same or another film, and/or another article that is not a film. “Outermost” layer herein includes a layer found on the outside of a film, i.e. a layer not bounded on both major surfaces by another film layer. Layers involved in heat sealing can include a second layer, adjacent an outermost layer, that assists in or substantially affects or influences the overall strength of the heat seal. Heat sealing can be performed by any one or more of a wide variety of manners known to those of ordinary skill in art, including using heat seal technique (e.g., melt-bead sealing, thermal sealing, impulse sealing, ultrasonic sealing, hot air, hot wire, infrared radiation, and the like), adhesive sealing, UV-curable adhesive sealing, and the like.

“Tie layer” and the like herein refers to an internal film layer having the primary purpose of adhering two layers to one another. In some embodiments, a tie layer can comprise any nonpolar polymer having a polar group grafted thereon, such that the polymer is capable of covalent bonding to polar polymers such as polyamide and ethylene/vinyl alcohol copolymer. In some embodiments, the tie layers can comprise modified polyolefin, modified ethylene/vinyl acetate copolymer, and/or homogeneous ethylene/alpha-olefin copolymer.

“Transparent” and the like herein refers to the ability of a material to transmit incident light with negligible scattering and little absorption, enabling objects to be seen clearly through the material under typical unaided viewing conditions, i.e. the expected use conditions of the material, as measured in accordance with ASTM D1746.

“Valve” and the like herein refers to any device by which the flow of material can be started, stopped, rerouted or regulated by a movable part that opens, closes, or partially obstructs a passageway through which the material flows. In some embodiments, a suitable valve can comprise any of an umbrella valve, duckbill valve, reed valve, ball valve, flapper valve, poppet valve, Gott valve, check valve, or any suitable combination thereof.

All compositional percentages used herein are presented on a “by weight” basis, unless designated otherwise.

The definitions and disclosure of the present application control over any inconsistent definition or disclosure present in an incorporated reference.

### II. Dispensing System 10

The present invention provides a dispensing system 10 and method for dispensing a product onto one or more areas (one or more spots of mustard dispensed on a hamburger bun, for example). In one embodiment, the dispensing system includes a packaging system 20 that cooperates with a dispensing device (such as a dispensing gun 30) to dispense a dose of product.

As illustrated in the Figures, packaging system 20 comprises outer container 40 with first and second ends 42, 44, and package 50 positioned within the container interior 43. Package 50 includes a pouch 60 that houses product 80, which in some embodiments can be a condiment. Pouch 60 includes an internal fitment 63 that accommodates dispensing assembly 100, including a valve 112, housing 120, diffuser 126, piercing component 115, and connecting portion 122. When the dispensing assembly is coupled to the pouch fitment 63, membrane 67 of the pouch fitment is pierced, and valve 112 enables product 80 to exit the pouch interior, via the passageway in pouch fitment 63, up through the plenum of housing 120, through valve 112, and through diffuser 126. The diffuser can have one or more outlets to distribute product flow.

### III. Packaging System 20

III.A. Generally

As illustrated in the Figures, packaging system 20 comprises container 40, package 50, and dispensing assembly 100.

III.B. Container 40

Container 40 includes tubular sidewall with open second end 44 sized to house package 50 and accommodate pusher plate 90 within the interior 43 of the container. The container further includes mouth positioned at first end 42, which accommodates fitment 63. The container in some embodiments can include a neck to which connecting portion 122 can be attached. Alternatively, connecting portion can attach to the exterior portion of fitment 63. Methods of attaching the dispensing assembly include a screw thread, location fit, press fit, twist lock, tab, slot, and/or snap fit arrangements.

Container 40 can be constructed from any of a variety of rigid or semi-rigid materials known in the art, e.g. plastic, metal, wood, cardboard, chipboard, stiff paper, foamed plastics, recycled materials, compostable materials, heavy foil, and/or combinations thereof; such as foamed or solid polystyrene, crystallized polystyrene (CPS), polyethylene terephthalate (PET), polypropylene, polyethylene, or combinations thereof. Such materials are typically suitable for forming, yet stiff or rigid enough to resist buckling, folding, crumbling or collapsing due to compression, handling, and shipping.

In some embodiments, container 40 can be constructed from a material that provides a barrier to the passage of oxygen, e.g., vinylidene chloride copolymer, nylon, polyethylene terephthalate, ethylene/vinyl alcohol copolymer, and the like. In some embodiments, the material(s) from which the container is constructed can comprise an oxygen scavenging material, e.g. Amisorb®. Alternatively or in addition, container 40 can comprise a substantially gas-impermeable sealant film laminated or otherwise bonded to the inner or outer surface thereof. In some embodiments, the material from which the container is made exhibits an oxygen transmission rate of no more than about 50 cc/m²/24 hr. at 25° C., 0% RH, 1 atm (in accordance with ASTM D 3985), such as no more than 10 cc/m²/24 hr. at 25° C., 0% RH, 1 atm.

Container 40 can be constructed using any conventional process known in the art, such as rotational molding, blow molding, reheat stretch blow molding, injection molding, casting, roll forming, stamping, and the like.

Container 40 is not limited to the cylindrical shape illustrated in the figures, and can have a rectangular, triangular, hexagonal, octagonal or square or other cross-sectional shape, including a combination of any of these shapes. The container be formed as any suitable receptacle with an interior 43 for housing a pouch, e.g. a carton, can, jar, or bottle, and can have different dimensions and volume capacities.

Optionally, container 10 includes one or more vent holes in the upper part of the container, e.g. in the shoulder 46 of the container. Such vent holes can expedite manual removal of a spent package from the container interior after product 80 has been dispensed.

III.C. Package 50

Package 50 includes sealed pouch 60, with product 80 disposed therein. Pouch 60 can be any of a variety of pouches known in the art, including e.g. a stand-up pouch, a gusseted stand-up pouch, a lay-flat pouch, a pouch comprising at least one longitudinal seal, and the like. In some embodiments, pouch 60 can comprise a pair of films joined together along a pair of opposing sides and a bottom bridging the sides. Alternatively, in some embodiments, pouch 60 can be formed from a single film that has been center folded at one edge, or a pouch that includes one or more lap seals, fin seals, and/or edge seals. In another embodiment, pouch 60 can comprise a continuous tubular material with no longitudinal seal, but with transverse seals as disclosed herein. The description of the pouch herein as having “first and second panels” should be understood to describe a pouch that when filled with product and laid on a surface, will display a major first surface, wall or panel, and, on the opposite side of the pouch, a second major surface, wall, or panel.

Pouch 60 as illustrated includes an aperture 65 disposed towards a dispensing end of the package 50. The aperture 65 is sized to accommodate fitment 63. The fitment 63 passes through the aperture 65 so that membrane 67 is disposed at or beyond the outer perimeter of the pouch 60. The fitment 63 is secured to the inside of the pouch 60 using a suitable bonding technique, such as heat sealing.

Pouch 60 can comprise first and second panels.

Pouch 60 and membrane 67 can be constructed from any of a wide variety of polymeric materials known in the art, including in some embodiments food safe materials and/or a base film having a food safe material coated thereon.

A film used to construct the disclosed pouch and/or membrane can be multilayer or monolayer. Typically, the films employed will have two or more layers to incorporate a variety of properties, such as, for example, sealability, gas impermeability, and toughness into a single film. Thus, in some embodiments, the films can comprise a total of from 1 to 20 layers, such as from 4 to 12, or from 5 to 9 layers. The films can comprise more than 20 layers e.g. in embodiments wherein the films comprise microlayering technology.

The films used to construct pouch 60 and/or the disclosed membrane 67 can include one or more barrier layers, bulk layers, tie layers, abuse layers, and/or sealant layers, e.g., at least one barrier layer such that the pouch has an oxygen transmission rate of no more than about 50 cc/m²/24 hr. at 25° C., 0% RH, 1 atm (in accordance with ASTM D 3985).

The polymer components used to fabricate the films can also comprise appropriate amounts of other additives normally included in such compositions. For example, slip agents (such as talc), antioxidants, fillers, dyes, pigments and dyes, radiation stabilizers, antistatic agents, elastomers, and the like can be added to the disclosed films. See, for example, U.S. Pat. Nos. 7,205,040; 7,160,378; 7,160,604; 6,472,081; 6,222,261; 6,221,470; 5,591,520; and 5,061,534, the disclosures of which are hereby incorporated by reference in their entireties. In some embodiments, pouch 60 and membrane 67 can be constructed from a food grade material, as would be well known to those of ordinary skill in the art.

The films used to construct pouch 60 and membrane 67 can have any total thickness so long as they provide the desired properties for the particular packaging operation in which they are to be used. Nevertheless, in some embodiments the disclosed films have a total thickness of from 0.1 mils to 20 mils, such as from 0.2 mils to 10 mils; 0.3 mils to about 5.0 mils; and from 1.0 mils to 3.0 mils. The films can be provided in sheet or film form and can be any of the films commonly used for the disclosed type of packaging, and can be constructed by any suitable process including e.g. coextrusion, lamination, extrusion coating, and combinations thereof. See, for example, U.S. Pat. No. 6,769,227, the content of which is herein incorporated by reference in its entirety.

In some embodiments, the films can be transparent (at least in any non-printed regions) such that the packaged product is at least partially visible through the films. The transparency of the films can be at least about any of the following values: 20%, 25%, 30%, 40%, 50%, 65%, 70%, 75%, 80%, 85%, and 95%.

In some embodiments the films used to construct pouch 60 or membrane 67 can be pigmented, tinted, or printed. Printing can be employed at any time prior to use of the pouch. In some embodiments, pouch 60 can be ink jet or thermal transfer printed using a device mounted on a packaging machine that forms and seals the pouch.

III.D. Product 80

System 20 can be used to house any of a wide variety of food and non-food products. For example, product 80 can include any of a wide variety of condiments, including (but not limited to) mustard, ketchup, salsa, guacamole, cheese sauce, sour cream, taco sauce, mayonnaise, tartar sauce, syrup, gravy, hot fudge, caramel, butterscotch toppings, flowable margarine and butter, horseradish, creamers, cream, yogurt, jelly, peanut butter, and the like. Liquids (such as water, milk, lemonade, and the like) can also be packaged in accordance with the present invention.

III.E. Method of Making a Package 50

Package 50 can be made by any suitable process, include a vertical form/fill/seal (VFFS) process. VFFS packaging systems are generally well known to those of skill in the art, and described for example in U.S. Pat. No. 4,589,247 (Tsuruta et al), U.S. Pat. No. 4,656,818 (Shimoyama et al.), U.S. Pat. No. 4,768,411 (Su), and U.S. Pat. No. 4,808,010 (Vogan), all incorporated herein by reference in their entirety.

Packages 50 can alternatively be made using horizontal form/fill/seal (HFFS) packaging systems, such as those available from Bossar, KHS-Bartelt, Mespack, Laudenberg, and other suppliers; and can also be made using rotary FFS systems such as those marketed by R A Jones, Cloud, etc.

III.F. Dispensing Assembly 100

As illustrated in the drawings, dispensing assembly 100 comprises a valve 112, a housing 120, a connecting portion 122 that is configured to functionally cooperate with and engage with fitment 63 and/or container 40, and a piercing component 115.

Connecting portion 122 can in some embodiments include a fastening device such as inner housing threads, for mating with the external surface of fitment 63 and/or container 40. Alternatively, connecting portion 122 can include any other suitable mechanism (such as location fit, press fit, twist lock, tab, slot, and/or snap fit arrangements) to cooperate with the fitment 63 and/or container 40. In some embodiments, the exterior of housing 120 includes a fastening device such as outer threads or a location fit, press fit, twist lock, tab, slot, and/or snap fit arrangement) that allow coupling with diffuser 126.

Valve 112 can be of any suitable variety known in the art, and can have at least one cut to form arms that move in response to increased pressure, such as from the advancement of the pusher plate 90, to form at least one passageway. Product 80 can travel from the interior of package 50, through fitment 63 and valve 112, to be dispensed on an item such as a food product, either directly, or indirectly by first entering and then exiting diffuser 126. Once pressure ceases, valve 112 closes. Valve 112 may fully close after pressure ceases, or alternatively remain slightly open (i.e., about 1-10% open), partially open (i.e., about 11-30% open), or somewhat open (i.e., about 31-50% open). Valve 112 can be constructed in any suitable shape, e.g. circular, square, oval, and the like. Although depicted as X-shaped in the figures, the valve arms can be also be constructed using any suitably shaped cut, e.g. slits, star, etc.

Housing 120, connecting portion 122, and piercing component 115 can be constructed from any suitable rigid or semi-rigid material known in the art, such as metal, wood, rubber, plastic, and the like; from polyethylene terephthalate, high density polyethylene, low density polyethylene, polyvinyl chloride, polypropylene, polystyrene, polycarbonates, or combinations thereof. Although depicted as circular in shape in the drawings, the housing can be formed in any desired shape, e.g. oval, circular, square, rectangular, and the like.

Valve 112 can be constructed from an appropriately flexible material, e.g. polymeric, rubber, silicone, polyester, thermoplastic polyester elastomer, and the like, including polymeric films that include these materials. In some embodiments, the materials used to form the valve and the shape of the valve cuts can be selected based on the product viscosity, as would be known to those of ordinary skill in the art. For example, products that include particulates (like tartar sauce) can be used with a flexible valve with large cuts to allow the particulates to pass through.

Valve 112 can be of any suitable type, such as an umbrella valve, duckbill valve, reed valve, ball valve, flapper valve, poppet valve, Gott valve, check valve, or any suitable combination thereof.

Valve 112 can be retained or seated in the housing 120 or diffuser 126 in any suitable manner. In one embodiment, a retainer, such as a retaining ring, is adapted to secure the valve within the housing or diffuser. A retaining clip, or a flange or flanges molded into the housing or diffuser, so as to retain the valve 112, can alternatively be used.

In some embodiments, a dispensing assembly comprises a diffuser comprising an outlet, a valve in juxtaposed relation to the outlet, a housing, a connecting portion that is configured to functionally cooperate with and engage a container, and a piercing component 115.

In one embodiment, the diffuser 126 is connected to the housing by a snap fit. This snap fit can be installed on the housing so as to render it not removable from the housing in normal use, i.e. is permanently installed on the housing. This particular feature of the invention can be beneficial when the use includes use of the combined housing/diffuser such that when desired, both are discarded as a unit. In some embodiments, the dispensing assembly does not include a diffuser; i.e. the overall packaging assembly, and the overall dispensing system, does not in every instance require a diffuser.

In some embodiments, the diffuser 126 can further include one or more conduits (not shown) or the like that extends through the interior of the space defined by the housing and the diffuser.

Diffuser 126 includes one or more outlets, that can be of any suitable size, shape, distribution and number, these choices dictated at least in part by the properties, e.g. viscosity or particulate content of the product being dispensed.

In one embodiment, a single disc of a thermoplastic and/or elastomeric material can be installed inside the diffuser 126, with a valve 112 positioned in each portion of disc 114 that is juxtaposed to and in communication with each respective outlet. For example, a diffuser 126 with three outlets can be underlain by a thermoplastic and/or elastomeric disc with a reed valve 112 positioned in each portion of disc 114 that underlies a respective outlet. The single disc can have a geometry suitable for fitting inside and suitably attaching to the interior (pouch side) of diffuser 126.

Alternatively, an individual disc bearing a valve 112 can be separately placed adjacent each outlet, such that e.g. three individual discs each bearing a valve 112, are present, but such an arrangement may be less convenient and more difficult to install than the embodiment employing a single disc.

Diffuser 126 with the underlain juxtaposed disc bearing valves 112 can be connected, integrally or as a discrete, attached component, to a housing 120. Diffuser 126 can be permanently attached to housing 120, or alternatively releasably attached thereto (for example, for purposes of cleaning between uses). Housing 120 provides a plenum for product 80 flowing out of package 50 to be directed to diffuser 126 and out through the individual valves 112 and outlets.

Diffuser 126 can be constructed from any suitable material, such as metal, wood, rubber, polyethylene terephthalate, high density polyethylene, low density polyethylene, polyvinyl chloride, polypropylene, polystyrene, polycarbonates, and combinations thereof. Although depicted as circular in shape in the drawings, the diffuser 126 and/or outlets 123 can be formed in any desired shape known in the art, e.g. oval, circular, square, rectangular, and the like.

Piercing component 115 can be made with any suitable geometry, provided it functions to pierce membrane 67 when the dispensing assembly is affixed to the package. Piercing can be accomplished by any suitable methodology, such as a twist of the dispensing assembly that, in combination with a steeply flighted screw thread, results in a downward thrust of piercing component 115, that results in piercing or puncture of membrane 67 to open the package, and enable flow of the flowable product 80 out of the package.

Pusher Plate 90

In one embodiment, packaging system 20 comprises pusher plate 90, configured to cooperate with piston 34 of a dispensing gun. The pusher plate is sized and shaped to be closely received within the container interior at second end 44 to help ensure that the package 50 is fully retained within the container 40 during dispensing. In some embodiments, pusher plate 90 can be configured to define a mating relationship with the interior surface 48 of container 40 when in contact. The pusher plate 90 is slidable within the interior of the container to ultimately allow product 80 to be dispensed from the package. When pressure is exerted on pusher plate 90 from a dispensing gun, the pusher plate reacts by slidably moving from container second end 44 towards container first end 42. As a result, pouch 60 is compressed, thereby increasing pressure on the package to dispense product 80.

In some embodiments, pusher plate 90 can be slightly undersized in relation to the inner diameter of container 40 allowing it (in conjunction with package 50) to wipe product as it transverses the length of the container, pushing toward the outlet. The package binds to the pusher plate 90 as it is retracted, thereby permitting easy removal of the used pouch.

The pusher plate can be a component of a dispensing gun instead of, or in addition to, a component of packaging system 20.

Suitable materials for use in constructing pusher plate 90 include (but are not limited to) plastic, wood, metal, rubber, and the like. In some embodiments, pusher plate 90 is configured as part of a dispensing gun. Alternatively, in some embodiments, the pusher plate can be configured as part of packaging system 20.

### IV. Dispensing Gun 30

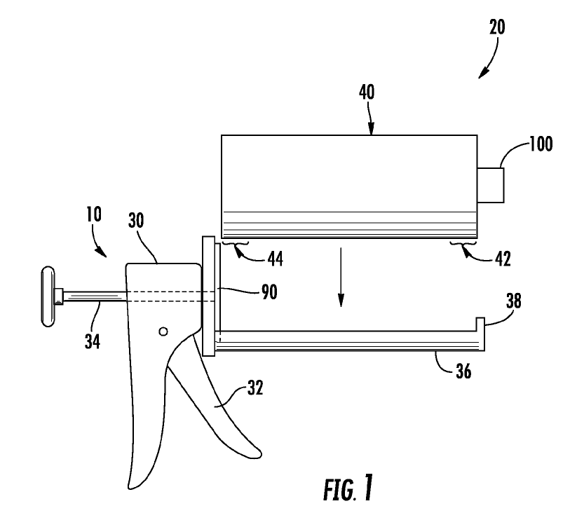

Dispensing gun 30 can comprise any apparatus that comprises a component of the disclosed dispensing system 10, and/or functions in cooperation with the disclosed packaging system 20, to dispense a product; as disclosed for example in U.S. Pat. Nos. 4,681,524; 5,211,311; 5,242,115; 5,462,204; 5,589,226; 5,812,355; and 5,875,922, the entire contents of which patents are hereby incorporated by reference herein. Dispensing gun 30 will typically comprise a mechanical device that can accommodate a packaging system as described herein, and can effect movement of a flowable product, contained in a flexible package, out of the package, through a dispensing valve, and onto an area. As shown in FIG. 1, the dispensing gun in one embodiment includes a trigger 32 to activate the dispensing system 10; a piston 34 to drive pusher plate 90 through the container 40 and thus push the flexible package 50 toward the first end 42 of the container; a barrel 36 to house packaging system 20; and a wall 38 against which the container 40 of packaging system 20 can abut.

The cylindrical pusher plate 90, is configured, when advanced by the piston into the container, to fit within the container in close proximity to the interior surface of the container. In one embodiment, the space between the annular outside edge of the pusher plate and the interior surface of the container, as the pusher plate passes through the interior of the container, is less than three times the thickness of the film thickness of the package; such as less than two times the film thickness of the package.

### V. Assembly of Packaging System 20

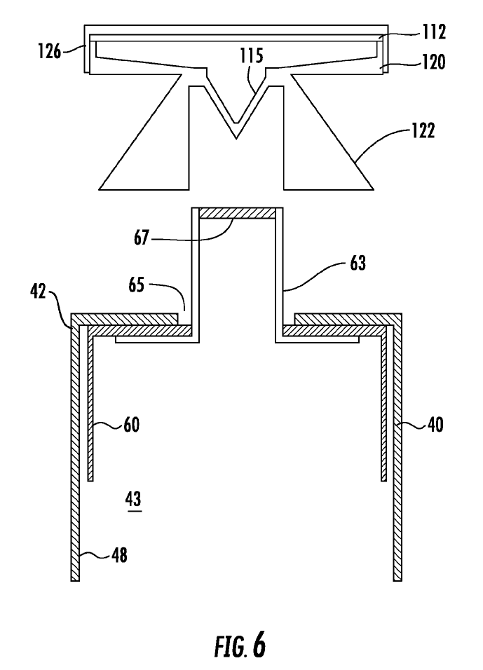

As a first step, package 50, including a sealed pouch 60 containing product 80, can be inserted into the interior of container 40 through second end 44 such that the pouch fitment 63 is positioned in an opening in container 40, as illustrated in FIG. 6. Dispensing assembly 120 is then seated flush atop the pouch fitment 63, in some embodiments with a twisting action or other activating step to pierce membrane 67 with piercing component 115.

It should be appreciated that the methods used to assemble packaging system 20 disclosed above are not limited and can performed in any suitable order. In some embodiments, the packaging system can be partially or fully pre-assembled such that a user need not perform all of the steps described herein.

### VI. Methods of Using Dispensing System 10

After assembly, packaging system 20 can be inserted into a dispensing gun 30, as shown in FIG. 1. In some embodiments, dispensing gun 30 can be of the type that dispenses a portion of the contents of pouch 60 upon each actuation. To this end, dispensing gun 30 can include trigger 32 that forms part of an actuating structure. Specifically, trigger 32 can be coupled to piston 34 that is movable within the interior of container 40 via contact with pusher plate 90. The actuating structure functions such that upon each movement of trigger 32, the piston 34 moves towards first end 42 of the container 40, and a bias spring returns the trigger to its original position. In some embodiments, dispensing gun 30 includes wall 38 that is configured to abut against the front end of system 20 (i.e. the first end 42 of container 40) so that pressure applied by the trigger 32 is effective to dispense product 80. Packaging system 20 can be used with any of a variety of dispensing guns known in the art. See, for example, U.S. Pat. Nos. 3,687,370; 3,945,569; 4,681,524; 5,462,204; 5,812,355; 5,875,922; 6,286,718; 6,454,138; 6,533,187; 6,691,899; and 7,011,238, the entire contents of which are hereby incorporated by reference.

To dispense product 80 disposed within pouch 60, a user can initiate trigger 32 on the dispensing gun 30. When trigger 32 is pulled, piston 34 advances pusher plate 90 within the interior of container 40 toward first end 42. Such movement reduces the volume of pouch 60, thereby collapsing the pouch and increasing the pouch internal pressure. Product 80 exits the pouch through pouch fitment 63 and valve 112 of housing 120. Product then passes through diffuser 126, if present, and out of system 20. Once the trigger has been pulled, a metered dose of product is dispensed and the valve prevents any substantial leakage of product.

Piston 34 will continue to move towards the second end 44 of container 40 with continued application of pressure (i.e., each pull of trigger 32), thereby dispensing product 80. When pusher plate 90 has reached an abutting position with container shoulders 46, the mating relationship ensures that a maximum amount of product housed within pouch 60 has been dispensed. System 20 can then be removed from dispensing gun 30 and replaced with a new system. As set forth above, in some embodiments, container 40, dispensing assembly 100, and/or pusher plate 90 can be used repeatedly such that only pouch 60 is replaced.

### VII. Advantages of the Present Invention

In some embodiments, the invention lowers costs associated with materials and assembly and with sufficient ruggedness to survive filling, closing, packing and shipping.

System 20 and/or pouch 60 can also be economically disposed of after a single use, or after the pouch contents have been dispensed.

The pouch is flexible, reducing storage space needed to house the pouch prior to use. Similarly, the space needed to ship the pouch is less than other alternatives. Further, the flexible pouch requires less space (in trash and in landfills) at the time of disposal.

In addition, pouch 60 is constructed to be substantially free of voids and to have suitable mechanical integrity and flexibility. As a result, the pouch can withstand high pressure treatment, such as can be used to reduce unwanted microorganisms in the packaged product.

The package further allows the dispensing of multiple doses of product in each dispensing application. For example, a package that includes a diffuser with five outlets will allow five spots of product to be dispensed with each pull of the dispensing gun trigger.

### VIII. Alternative Embodiment of the Invention

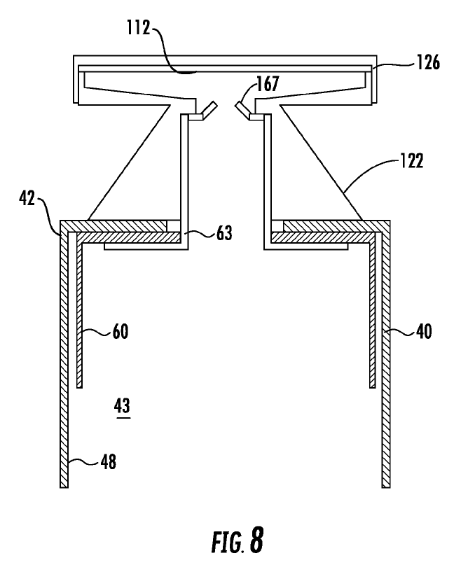

As illustrated in FIG. 8, fitment 63 may include a membrane 167 that is constructed as or with a frangible seal. A frangible seal may be constructed from multiple layers using a heat seal, ultrasonic seal, static seal, RF seal, adhesive, or a combination thereof. Frangible seals are known to those of ordinary skill in the packaging art. See, for example, U.S. Pat. No. 6,983,839 and U.S. Patent Application Publication No. 2006/0093765, the entire disclosures of which are hereby incorporated by reference. Alternatively, a frangible seal of the type disclosed in commonly assigned PCT application PCT/US2015/041539 filed 22 Jul. 2015, the disclosure of which is hereby incorporated by reference, may be used. In any case, membrane 167 with a frangible seal may open upon exerting pressure on the product 80 within the pouch 60. The frangible seal may be broken before or after inserting the pouch into the container 40. In the latter case, pressure can be exerted on pusher plate 90 from a dispensing gun piston 34 and the pusher plate 90 reacts by slidably moving from container second end 44 towards container first end 42. As a result, pouch 60 is compressed, thereby increasing pressure on the package to compress product 80. The compressive force applied to the product 80 then acts to break the frangible seal of membrane 167. Notably, a fitment 63 that includes a membrane 167 with a frangible seal can still be used with a dispensing assembly with a piercing component 115. In other words, the frangible seal can either be forced open under pressure or pierced.

### IX. Statement of Embodiments of the Invention

The present application is directed in various embodiments to the subject matter described in the following paragraphs. These are alternative embodiments of any of the first (dispensing system), second (packaging system), third (package), fourth (dispensing assembly), and fifth (method of dispensing a product) aspects of the invention as described hereinabove in the Summary of the Invention. For each aspect, these features can be incorporated alone or in any suitable combination of these features:

a) a pusher plate is positioned either within the container interior, or in the dispensing gun, and adapted to movably close the first opening and effect dispensing of product.

b) the container comprises a rigid cylindrical container.

c) the container comprises a neck portion adapted to connect to a dispensing assembly.

d) the container comprises a neck portion adapted to house an exterior fastening member.

e) the fastening member of d) is selected from the group comprising: a location fit, a press fit, a screw thread, a twist lock, a tab, a slot, a snap fit, or combinations thereof.

f) the pouch comprises a flexible, thermoplastic pouch.

g) the pouch has an oxygen transmission rate of no more than 50 cc/m²/24 hr. at 25° C., 0% RH, 1 atm in accordance with ASTM D 3985.

h) the flowable product comprises a condiment.

i) the valve is selected from the group comprising an umbrella valve, a duckbill valve, a reed valve, a ball valve, a flapper valve, a poppet valve, a Gott valve, a check valve, and combinations thereof.

j) the valve comprises four arms defined by a cross-cut in a central portion of the valve.

k) the dispensing assembly comprises a retainer adapted to secure the valve within the housing or diffuser.

l) the retainer is selected from a retaining ring, a retaining clip. or a flange.

m) the housing comprises an interior surface and an exterior surface, at least one of which comprises a fastening member selected from the group comprising a location fit, a press fit, a screw thread, a twist lock, a tab, a slot, a snap fit, or combinations thereof.

o) the diffuser is connected to the housing with a snap fit.

p) the diffuser comprises two or more outlets.

q) a product is positioned within the interior of the pouch, wherein the product is a flowable food product.

r) the diffuser comprises an interior comprising a fastening member selected from the group comprising: a location fit, a press fit, a screw thread, a twist lock, a tab, a slot, a snap fit, or combinations thereof.

s) movement of the pusher plate is accomplished by pulling a dispensing gun trigger.

t) a metered volume of product is dispensed.

u) the dispensing gun comprises a barrel having a substantially hemispheric cross section.

v) the dispensing gun comprises a piston and a trigger.

w) the cylindrical pusher plate is configured, when advanced by the piston into the container, to fit within the container in close proximity to the interior surface of the container, with a gap between the outside diameter of the pusher plate and the interior surface of the container, of between 0.05 mm and 1 mm.

x) the cylindrical pusher plate comprises a first and second planar surface, the first and second planar surfaces substantially parallel to one another,

a circumferential edge having a thickness “T”, the circumferential edge normal to and joining the first and second planar surfaces, and a circumferential bevel located on the first planar surface and joining the first planar surface to the circumferential edge.

y) movement of the pusher plate is accomplished by pulling a dispensing gun trigger.

z) the container comprises an interior surface having a low COF.

aa) the container comprises an interior surface that exhibits a COF of between 0.05 and 0.5.

bb) the film comprises an exterior surface having a low COF.

cc) the film comprises an exterior surface that exhibits a COF of between 0.05 and 0.5.

dd) in a dispensing assembly, a valve in juxtaposed relation to an outlet of the diffuser;

ee) in a dispensing assembly, a single disc, juxtaposed adjacent the diffuser, bears a valve.

ff) in a dispensing assembly, a single disc, juxtaposed adjacent the diffuser, bears a plurality of valves, each valve positioned adjacent a respective outlet.

1-15. (canceled)

16. A packaging system comprising:
a) a container comprising first and second openings and an interior;
b) a package positioned within the container interior, the package comprising a pouch comprising a first and second panel with an aperture, an internal pouch fitment disposed in the aperture, the pouch fitment comprising a membrane, and a flowable product disposed in the pouch; and
c) a dispensing assembly.

17. The packaging system of claim 16 further comprising a pusher plate positioned within the container interior and adapted to movably close the first opening and effect dispensing of product.

18. The packaging system of claim 16, wherein the container comprises a rigid cylindrical container.

19. The packaging system of claim 16, wherein the container comprises a neck portion adapted to connect to the dispensing assembly.

20. (canceled)

21. The packaging system of claim 16 wherein the dispensing assembly comprises a piercing component configured to pierce the membrane.

22. (canceled)

23. The packaging system of claim 16, wherein the membrane comprises a frangible seal.

24. The packaging system of claim 16, wherein the dispensing assembly comprises
a) a valve,
b) a housing,
c) a connecting portion that is configured to functionally cooperate with and engages the container or pouch fitment, and
d) a piercing component.

25-27. (canceled)

28. The packaging system of claim 24, further comprising a diffuser connected to the housing.

29-30. (canceled)

31. A package comprising:
a) a pouch comprising a first and second panel with an aperture, an internal fitment comprising a membrane, the internal fitment disposed to pass through the aperture so that the membrane is disposed at or beyond an outer perimeter of the pouch, and
b) a flowable product disposed in the pouch.

32-33. (canceled)

34. The package of claim 31, wherein the membrane comprises a frangible seal.

35-43. (canceled)

44. A method of dispensing a product, comprising:
a) providing a packaging system comprising
i) a container comprising a first and second end, first and second openings and an interior,
ii) a package positioned within the container interior, the package comprising a pouch comprising a first and second panel with an internal fitment comprising a membrane, and a flowable product disposed in the pouch; and
iii) a dispensing assembly;
b) providing a dispensing gun configured to house the packaging system;
c) installing the packaging system into the dispensing gun; and
d) initiating linear movement of a pusher plate through the interior of the container to cause the flowable product to be dispensed through the dispensing assembly.

45. The method of claim 44 wherein movement of the pusher plate is accomplished by activating a dispensing gun trigger.

46. The method of claim 44, wherein a metered volume of product is dispensed.

47. The method of claim 44, wherein the product is a condiment.

48. The method of claim 44, wherein the dispensing assembly comprises a piercing component configured to pierce the membrane, the method further comprising piercing the membrane by coupling the dispensing assembly to the internal fitment.

49. The method of claim 44, wherein the membrane comprises a frangible seal, the method further comprising the step of bursting the frangible seal by initiating linear movement of the pusher plate against the package.

50. The packaging system of claim 17 wherein the packaging system is configured to engage a dispensing gun, the dispensing gun comprising a trigger to drive the pusher plate through the container and push the package toward the first opening of the container.

51. The package of claim 31, wherein the internal fitment is configured to engage a dispensing assembly, the dispensing assembly comprising a piercing component configured to pierce the membrane.

52. The package of claim 31, wherein the internal fitment is configured to engage a dispensing assembly, the dispensing assembly comprising:
a) a valve,
b) a housing,
c) a connecting portion that is configured to functionally cooperate with and engage the internal fitment, and
d) a piercing component configured to pierce the membrane.
